(19) United States
(12) Patent Application Publication
(10) Pub. No.: US 2002/0113736 A1
(43) Pub. Date: Aug. 22, 2002

(54) Compact printed "patch" antenna

(75) Inventors: Yann Toutain, Brest (FR); Jean-Philippe Coupez, Brest (FR); Jean-Pierre Blot, La Turbie (FR)

Correspondence Address: Lawrence E. Laubscher, Sr., 745 South 23rd Street, Arlington, VA, 22202-2451, US

(73) Assignee: FRANCE TELECOM, Paris (FR)

(21) Appl. No.: 10/023,978

(22) Filed: Dec. 21, 2001

(30) Foreign Application Priority Data
Dec. 26, 2000 (FR) 00-17257

(51) Int. Cl. H01Q 1/38

(52) U.S. Cl. 343/700 MS

(57) ABSTRACT

A half-wave printed “patch” antenna includes, symmetrically with respect to a plane of symmetry of the antenna perpendicular to faces of the antenna, a dielectric substrate and two conductive layers on respective faces of the substrate. One face of the substrate includes a raised portion extending lengthwise of the plane of symmetry and one of the conductive layers extends over and along said raised portion. Consequently, the antenna has a small size, combined with a more open radiation diagram. The antenna includes only one raised portion for linear polarization, or two raised portions or a raised portion with axial symmetry for crossed polarizations.

### BACKGROUND OF THE INVENTION

1—Field of the Invention

The present invention relates to a plated technology “patch” printed antenna, for operation with linear or circular polarization at frequencies of the order of a few gigahertz. In particular, the antenna is intended to be replicated in order to be integrated into an array for receiving and/or sending telecommunication signals on board a craft, such as a satellite in low earth orbit, or to be installed in a base station in communication with a telecommunication satellite, or to be installed in a base station for radio communications with mobile terminals.

2—Description of the Prior Art

The invention is more particularly directed to a “patch” half-wave printed antenna including a dielectric substrate and two conductive layers on respective faces of the substrate. One of the layers constitutes a ground plane. The other layer is a rectangular or square conductive plate known as a “patch”. This kind of individual printed antenna is easy to integrate and has a low fabrication cost thanks to a simple machining process.

However, the electrical characteristics of the antenna depend considerably on the dielectric material of the substrate on which the two conductive layers are etched.

If the dielectric substrate is thin and has a high dielectric permittivity, the antenna is relatively inefficient and its bandwidth is narrow.

To obtain a more efficient antenna the dielectric substrate must be thick and consist of a material with a low dielectric permittivity. However, the antenna obtained in this way is significantly larger, which makes it difficult to integrate it into an array. Also, the radiation diagram of the antenna is less open.

### OBJECT OF THE INVENTION

The main object of this invention is to provide a highly efficient “patch” half-wave printed antenna of smaller size than in the prior art referred to above and having a more open radiation diagram.

### SUMMARY OF THE INVENTION

Accordingly, a half-wave printed antenna comprising a dielectric substrate and two conductive layers extending on respective faces of the substrate and symmetrical with respect to a plane of symmetry of the antenna perpendicular to the faces of the substrate, is characterized in that a raised portion extends lengthwise of the plane of symmetry on one face of the substrate, one of said conductive layers extending over and along the raised portion.

For an antenna with linear polarization, the conductive layer extending over and along the raised portion can have a contour for example rectangular and constitute a radiating element, and the other conductive layer can constitute a ground plane. According to another embodiment, the conductive layer extending over and along the raised portion can constitute a ground plane and the other conductive layer can be plane, for example rectangular, and constitute a radiating element.

The raised portion which can have a cross section in the plane of symmetry that is rectangular, sinusoidal, trapezoidal or triangular, has a height substantially equal to half the distance between the lengths of the longer and shorter sides of the layer, which is rectangular, extending over and along the raised portion. However, the height of the raised portion is generally chosen as a function of the intended compactness of the antenna; as the height of the raised portion increases, the size of the antenna decreases.

The other face of the substrate can include another raised portion extending lengthwise of the plane of symmetry and covered by the other conductive layer.

For an antenna with crossed polarizations, in particular circular or elliptical polarization, one face of the substrate includes two mutually perpendicular raised portions forming a striking cross, extending lengthwise of two respective planes of symmetry of the antenna. The conductive layer of the antenna extending over and along the raised portions can occupy a rectangular or square surface on the dielectric substrate whose sides are the same lengths as the respective raised portions.

The antenna with crossed polarizations preferably includes a hybrid coupler that is formed on a dielectric support and lodged in the dielectric substrate and has a port connected to an end of an inner conductor of a coaxial probe and at least another port connected by a metal via to the conductive layer extending over and along one of the raised portions.

In variant, the two raised portions on one face of the substrate are replaced by a raised portion with axial symmetry about an axis perpendicular to the faces of the substrate.

The invention also relates to a method of fabricating the “patch” printed antenna, which method includes machining one face of a block of dielectric substrate to form cavities separated by at least one strip having the same section as a raised portion extending lengthwise of the plane of symmetry, metallizing at least the face of the block with the machined dielectric raised portion to form one of the conductive layers, and cutting out the printed antenna substantially at the center of the metallized and machined block following the contour of the antenna.

### BRIEF DESCRIPTION OF THE DRAWINGS

Other features and advantages of the present invention will become more clearly apparent on reading the following description of preferred embodiments of the invention, which description is given with reference to the accompanying drawings.

FIGS. 1 and 2 are respectively a view in section taken along the line I-I in FIG. 2 and a plan view of a “patch” printed antenna with linear polarization conforming to a first preferred embodiment of the invention;

FIGS. 3 and 4 are respectively a view in section taken along the line III-III in FIG. 4 and a plan view of a “patch” printed antenna with linear polarization conforming to a second preferred embodiment of the invention;

FIG. 5 shows two electric field radiation diagrams respectively relating to a “patch” antenna of the prior art and a “patch” antenna conforming to the first embodiment;

FIGS. 6 and 7 are respectively plan and perspective views of an unprocessed block of dielectric foam during a first step of fabricating an antenna according to the invention

FIGS. 8 and 9 are respectively plan and perspective views of the machined block of dielectric foam during a second step of the fabrication method

FIGS. 10 and 11 are respectively plan and perspective views of the machined and metallized block of foam during a third step of the fabrication method;

FIGS. 12 and 13 are respectively plan and perspective views of the machined and metallized block of foam after another machining step of the fabrication method;

FIGS. 14 and 15 are views in section analogous to FIG. 1, respectively showing raised portions with a sinusoidal profile and a staircase profile;

FIG. 16 is a view in section analogous to FIGS. 1 and 3 of an antenna with two superposed raised portions on two respective faces of the substrate

FIG. 17 is a perspective view of a “patch” printed antenna with circular polarization and a hybrid coupler, the antenna conforming to a third embodiment of the invention and a quarter-sector of the antenna being cut away;

FIGS. 18 and 19 are respectively a plan view and a view in section taken along the line XIX-XIX of the antenna shown in FIG. 17;

FIG. 20 shows variations of matching and transmission as a function of frequency for the third embodiment of the antenna;

FIG. 21 is a perspective view of a printed antenna with crossed polarizations.

### DESCRIPTION OF THE PREFERRED EMBODIMENTS

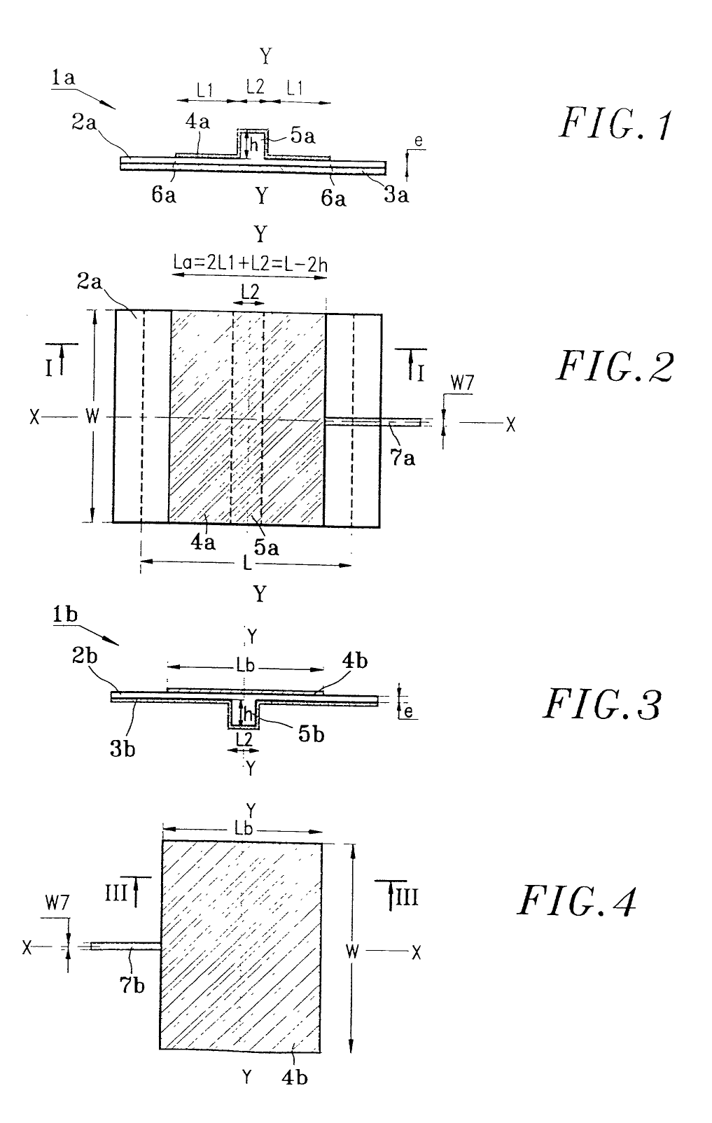

Referring to FIGS. 1 and 2, a “patch” half-wave printed antenna 1a with linear polarization conforming to the first embodiment of the invention includes a dielectric substrate 2a, a first electrically conductive layer 3a on a first face of the substrate and constituting a ground plane, and a rectangular second electrically conductive layer 4a at the center of the second face of the substrate and having a parallelepiped-shaped central raised portion 5a. The second conductive layer 4a has a rectangular contour and covers the top and the longitudinal sides of the raised portion 5a. The antenna therefore has a structure which is symmetrical with respect to a plane of symmetry YY perpendicular to the faces of the substrate 2a and lengthwise of the raised portion 5a. The layer 4a has a U-shaped section with projecting ends, as shown in FIG. 1, with wings on the second face of the substrate 2a having a width L1 much greater than the width L2 of the raised portion 5a. Generally speaking, the height h of the raised portion 5a is equal to or greater than the thickness e of the substrate 2a.

Compared to a prior art flat radiating patch having a width W and a length L, often equal to W, as shown in dashed line in FIG. 2, the length La of the antenna 1a according to the invention is reduced to:

La=2L1+L2=L−2h.

Thanks to the raised portion 5a across the whole width W of the antenna, the length of the radiating element consisting of the second conductive layer 4a is significantly reduced. This reduction in length moves the radiating slots 6a at symmetrical ends of the “patch” antenna 1a closer together, which opens out the radiation diagram in the plane of the electric field perpendicular to the raised portion 5a.

The substantial thickening at the center of the substrate 2a formed by the raised portion 5a covered with the conductive layer 4a extends the resonant electrical dimension of the half-wave antenna and thereby increases the characteristic impedance at the center of the antenna, which is equivalent to a pseudo-short-circuit. The raised portion significantly reduces the size of the antenna for a given operating frequency. As the impedance of the raised portion at the center of the antenna increases, the width L2 of the raised portion must decrease for a given frequency at resonance.

FIG. 2 also shows a microstrip line 7a having a width W7 significantly less than the width W of the radiating element 4a and extending perpendicularly thereto as far as the middle of the longer side of a wing of width L1 of the layer 4a. The microstrip line corresponds to a quarter-wave transformer and has the function of matching the impedance of the antenna to the characteristic impedance of the antenna feed line, which is typically 50 Ω. Another solution to feeding the antenna entails using a coaxial probe whose inner conductor is connected to a point of the antenna, such as a wing of the layer 4a, having an input impedance equal to the characteristic impedance.

In FIGS. 3a and 4, which relate to a second embodiment of a “patch” half-wave printed antenna 1b according to the invention, components similar to those of the antenna la of the first embodiment are designated by the same reference number with the suffix b in place of the suffix a.

The “patch” half-wave printed antenna 1b is a dual variant of the first embodiment and is again symmetrical with respect to a plane of symmetry YY perpendicular to the faces of the substrate 2b. The symmetrical raised portion 5a, instead of being on the second face of the dielectric substrate 2a supporting the rectangular radiating element 4a, is on the first face of the substrate 2b supporting the first conductive layer 3b constituting the ground plane of the antenna 1b. The radiating element 1b is a completely plane rectangular conductive patch 4b over and extending along the axis of the raised portion 5b. The length Lb of the conductive layer 4b still conforms to the preceding equation:

Lb=L−2h

where h denotes the height of the raised portion 5b of width L2.

By way of example, table I below indicates the resonant frequency corresponding to a wavelength λ, the bandwidth centered on the resonant frequency, as a percentage thereof, and the directivity, firstly for a prior art antenna TA including a square plane patch of width W=L=50 mm=λ/(2\sqrt{∈ᵣ}) and a substrate having a thickness e=2 mm and made from foam having a relative permittivity ∈ᵣ=1.07, substantially equivalent to a layer of air, and secondly for conformal antennas 1a1 to 1a4 with linear polarization conforming to the first embodiment (FIGS. 1 and 2 ) and with a length La=L−2h<λ/(2\sqrt{∈ᵣ}).

TABLE 1

| | TA | 1a1 | 1a2 | 1a3 | 1a4 |
|---|---|---|---|---|---|
| h (mm) | 0 | 2 | 4 | 6 | 8 |
| Resonant | 2.63 | 2.43 | 2.28 | 2.21 | 2 |
| frequency | | | | | |
| (GHz) | | | | | |
| Bandwidth | 1.7% | 1.9% | 2% | 2.2% | 2.4% |
| Directivity | 9.4 | 8.47 | 7.68 | 7.14 | 6.64 |
| (dB) | | | | | |

From table 1 above, as the height h of the raised portion 5a, or to be more precise the ratio h/e, increases, and to a lesser degree, as the width L2 of the raised portion 5a increases, the bandwidth of the antenna increases and the directivity of the antenna decreases.

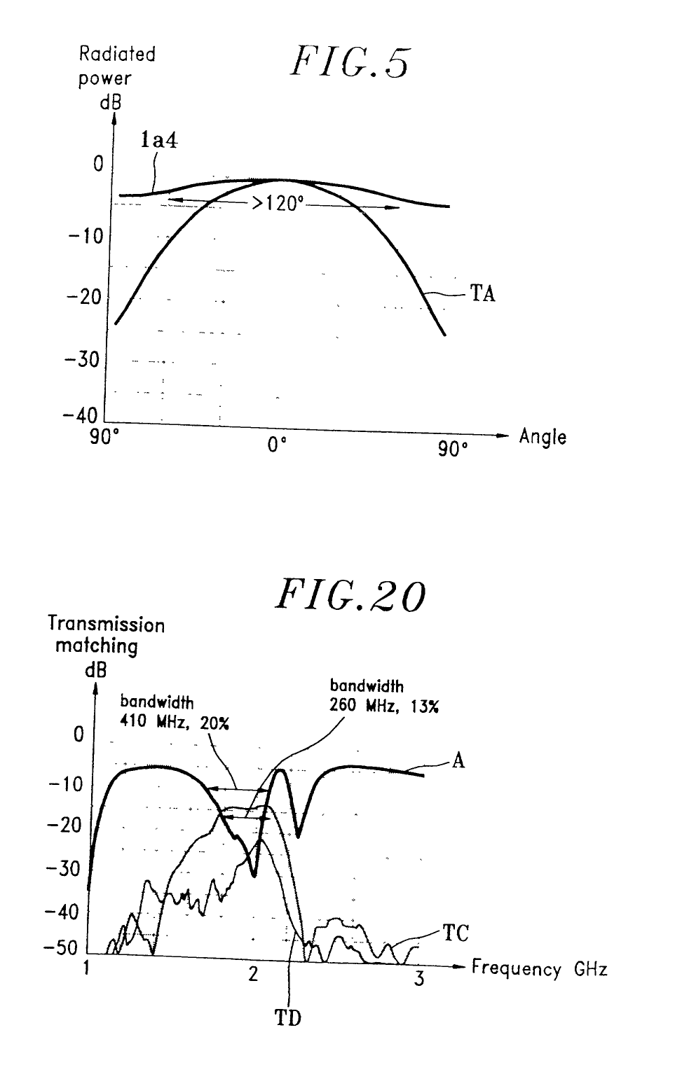

As shown in FIG. 5, the radiation diagram in the plane of the electric field perpendicular to the raised portion 5a has an aperture proportional to the height h of the raised portion, which is much wider, for the antenna 1a4, for example, than the aperture of the radiation diagram of the prior art antenna TA. The aperture of the antenna 1a4 at half the radiated power (3 dB) is approximately 120°.

These properties offer greater freedom with respect to the relative positions of antennas according to the invention placed in an array because of the relative reduction in the dimensions of the antenna. Also, the beam from an array of antennas according to the invention can be depointed to a much greater extent because the radiation diagram of the antenna is more open.

Thus by appropriately adapting the height h of the raised portion 5a, the aperture of the radiation diagram at 3 dB can vary from approximately 60° to at least approximately 120°. The radiation efficiency remains above 90% for all antennas according to the invention.

Similar results have been obtained for antennas 1b1 to 1b4 conforming to the second embodiment of the invention, with a conformal ground plane 3b with a raised portion 5b, as shown in table 2 below, again for antennas with the dimensions Lb=L=50 mm and e=2 mm.

TABLE 2

| | TA test | 1b1 | 1b2 | 1b3 | 1b4 |
|---|---|---|---|---|---|
| h (mm) | 0 | 2 | 4 | 6 | 8 |
| Resonant | 2.63 | 2.3 | 2.09 | 1.95 | 1.82 |
| frequency | | | | | |
| (GHz) | | | | | |
| Bandwidth | 1.7% | 1.9% | 2.1% | 2.3% | 2.5% |
| Directivity | 9.4 | 7.9 | 7 | 6.4 | 6.1 |
| (dB) | | | | | |

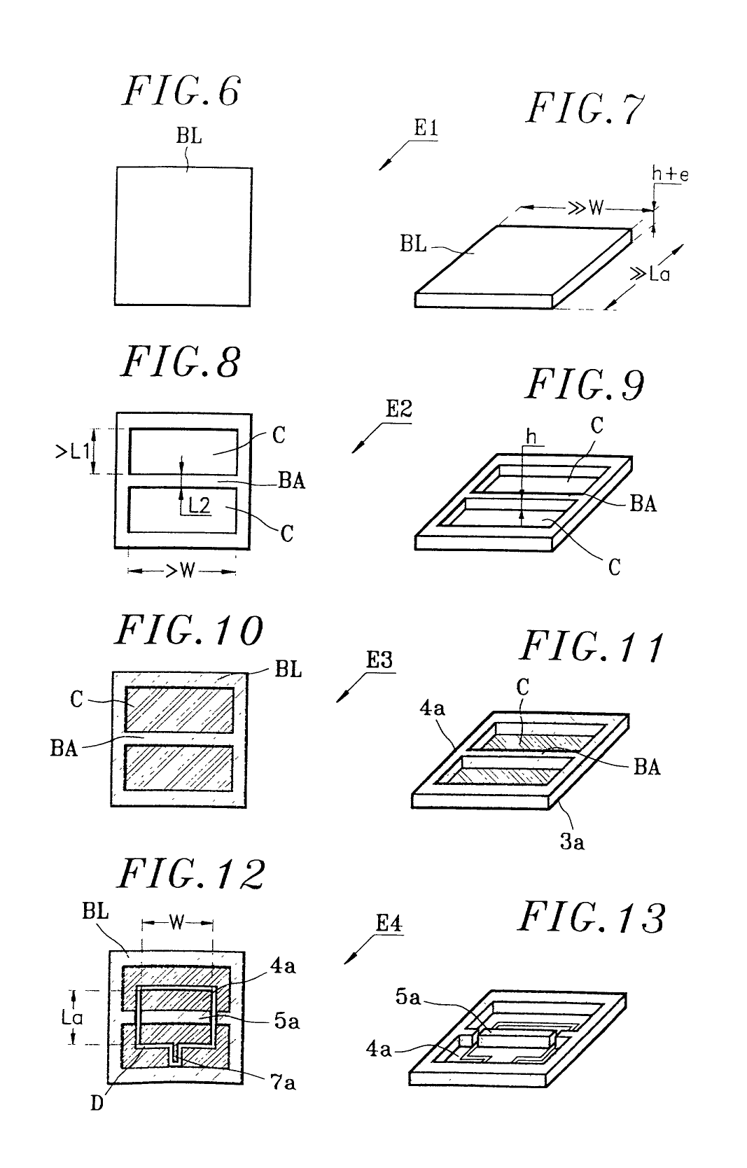

A preferred method for fabrication of a linear polarization antenna according to the invention includes four steps E1, E2, E3 and E4 shown in FIGS. 6-7, 8-9, 10-11 and 12-13, respectively.

In the initial step E1, fabrication starts with a thin block of foam BL of thickness h+e, of width greater than W and of length greater than La. The dielectric material of the block BL, into which the dielectric substrate 2a will be machined, has a typical relative permittivity of the order of 1.07, in conjunction with a length L=50 mm<λᵣ/2 with λᵣ=λ/\sqrt{∈ᵣ}, where λ is the wavelength corresponding to a frequency of the order of 2 GHz.

In step E2, two rectangular cavities C with a bottom of thickness e are machined symmetrically with respect to the transverse axis in one face of the block BL so that the cavities are separated by a transverse strip BA having the same section (h×L2) as the raised portion 5a. The cavities C have a width greater than L1 and a length greater than W.

Then, in step E3, the top face of the block BL with the cavities is metallized by depositing a layer of metallic paint to constitute the conductive layer 4a. In particular, the metallic paint covers the strip BA and the bottom of the cavities C. The metallic paint also covers the bottom face of the block to constitute the ground plane 3a. As an alternative to this, instead of the metallization of the bottom face, the ground plane 3a can consist of a metal support to which the machined block of foam is fixed.

Finally, in step E4, the antenna 1a is cut at D by a second operation of machining the metallized block along the rectangular contour (W×La) of the conductive layer 4a and the elongate rectangular contour of the microstrip feed line 7a.

An antenna 1b with a conformal ground plane 3b with a raised portion 5b can equally be machined from a block of dielectric foam BL by method steps analogous to the above steps E1 to E4.

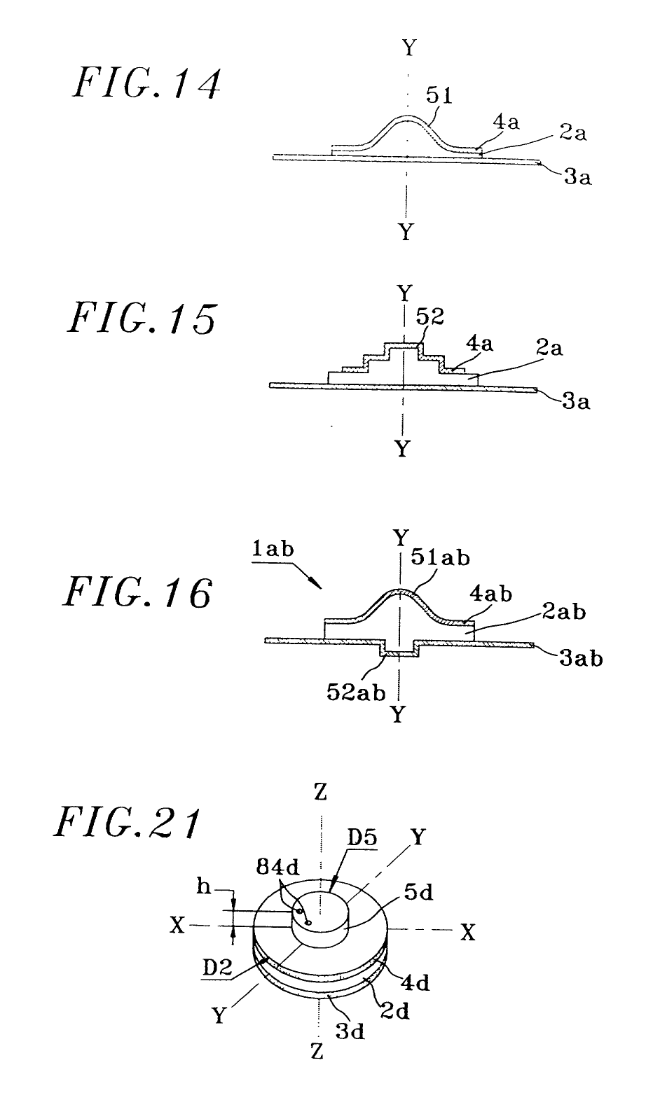

The section of the raised portion 5a, 5b transverse to the plane of symmetry YY is not limited to the rectangular or square profile shown in FIGS. 1 and 3. Reducing the length of the antenna from L to La, Lb, generating a central area of very high impedance, can be the result of some other symmetrical profile of the cross section of the raised portion, for example a substantially sinusoidal profile 51, as shown in FIG. 14, or a substantially isosceles trapezoidal or isosceles triangular profile, or a substantially staircase-shaped profile 52, as shown in FIG. 15, with treads parallel to or inclined to the faces of the substrate.

In another embodiment, the antenna comprises stacked parallel raised portions on both faces of the substrate. For example, as shown in FIG. 16, the faces of the substrate 2ab of the antenna 1ab respectively include a first raised portion 52ab with a rectangular cross section for the first conductive layer 3ab of ground plane and a second raised portion 51ab with a sinusoidal cross section for the second conductive layer 4ab of radiating element. The raised portions 52ab and 51ab extend one on top of the other lengthwise of the plane of symmetry YY and are respectively covered by the layers 3ab and 4ab.

Compared to a ground return quarter-wave antenna that is not symmetrical with respect to two planes, and despite the raised portions 5a, 5b, the half-wave antenna 1a, 1b embodying the invention retains two-fold symmetry with respect to the plane of symmetry YY lengthwise of the raised portion and a plane of symmetry XX perpendicular to the raised portion and lengthwise of the feed line 7a, as indicated in FIGS. 2 and 4.

This two-fold symmetry confers the advantages of the raised portion on an antenna with two crossed polarizations, and more particularly an antenna with circular polarization described hereinafter.

Referring now to FIGS. 17, 18 and 19, a circular polarization printed antenna 1c according to the invention has a structure with two-fold symmetry with respect to two planes of symmetry XX and YY perpendicular to each other and to the faces of the antenna.

The antenna 1c has on a first face of a thin dielectric substrate 2c of thickness e, a metal layer 3c, which can be a metal base, to constitute the ground plane of the antenna 1c, and at the center of a second face of the substrate 2c, a conductive layer 4c covering two identical and mutually perpendicular raised portions 5c to form a central cross with four equal-length arms. Like the raised portions 5a and 5b, the raised portions 5c have a height h that is generally greater than the thickness e of the substrate 2c, and a length Lc such that:

Lc=L2+2.L1=L−2h

where L2 designates the width of each raised portion, L1 the width of the four square surfaces of the metallic layer 4c disposed on the second face of the substrate 2c at the base of the cross formed by the raised portions 5c, and L is the corresponding length of a plane square patch of a prior art antenna.

The antenna 1c therefore has two mutually perpendicular planes of symmetry XX and YY respectively lengthwise of the crossed raised portions 5c and a conductive layer 4c forming a radiating element on the substrate 2c having a smaller square surface (Lc×Lc).

In practice, the dielectric substrate 2c consists of a dielectric foam of low permittivity ∈ᵣ=1.07, whose top face is machined in an analogous manner to the substrate 2a, 2b to obtain the crossed raised portions 5c, and a small square dielectric support 21c set into a central cavity on the first face of the substrate 2c and covered by the metal layer 3c. The relative permittivity of the support 21c is higher, for example ∈ᵣ=10.2 in the case of an AR1000 dielectric from the firm ARLON.

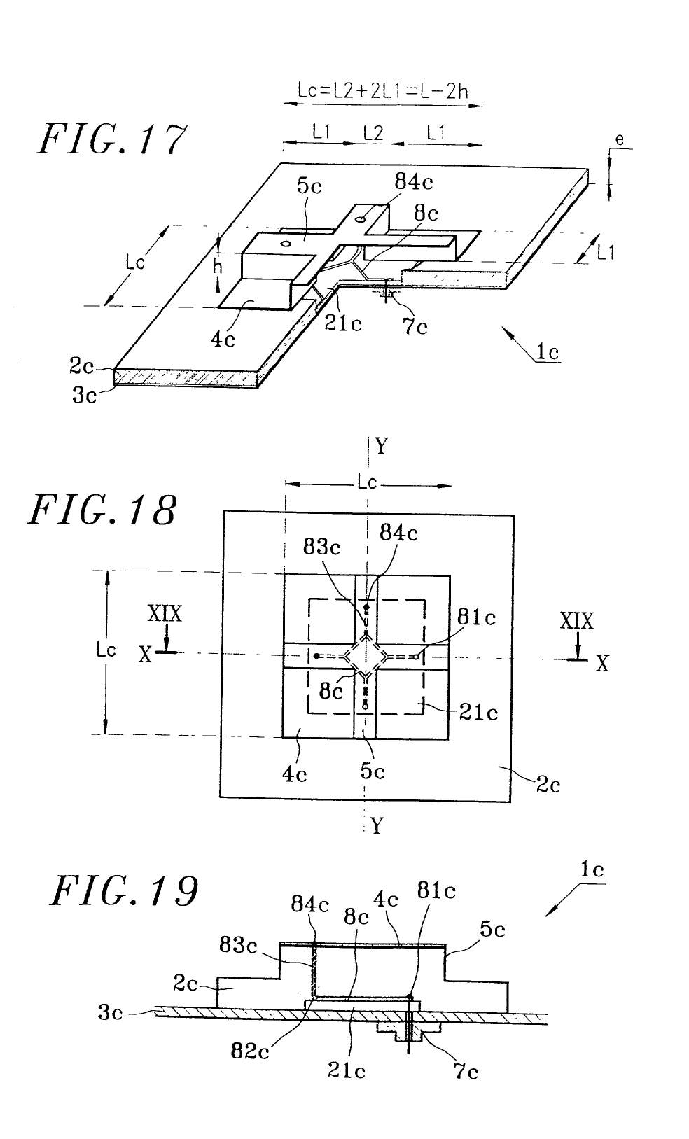

As shown in detail in FIGS. 17 to 19, the antenna 1c is fed by a coaxial probe 7c whose outer conductive base is fixed to the ground plane 3c and whose inner conductor passes only through the dielectric support 21c. The end of the inner conductor of the coaxial probe 7c is soldered to the end of a branch 81c forming a port at one extremity of a 3 dB−90° hybrid coupler 8c. The coupler 8c is configured substantially according to the contour of a square and is photo-etched on the top face of the support 21c. Another port, situated at the front in FIGS. 17 and 18, can be connected to the inner conductor of a second coaxial probe (not shown) for operation with crossed polarizations. The other two ports 82c of the coupler 8c are extended by metallic vias 83c that are formed through the end of the two raised portions 5c and whose ends are in metallic contact through soldered connections 84c with the conductive layer 4c over the raised portions 5c.

The relative permittivity of the dielectric support 21c is much higher than that of the substrate 2c so that, for the operating frequencies of the antenna, which are of the order of one gigahertz, the dimensions of the coupling 8c are small and therefore compatible with the compactness of the antenna.

Insofar as the dielectric foam block 21c is concerned, the antenna 2c is fabricated, by substantially method steps analogous to the above steps E1 to E4, by machining four cavities to form two cruciform strips which, after cutting, form the two perpendicular raised portions 5c, and by excavating an underlying cavity to lodge the dielectric support 21c supporting the hybrid coupler 8c.

For example, the dielectric substrate 21c has an overall thickness e of 10 mm with a 635 μm thick cavity to lodge the 635 μm thick dielectric support 21c. The conductive layer 4c covering the crossed raised portions 5c has a width Lc=25 mm for raised portions 5c having a height h=8 mm relative to a usable thickness e=2 mm of the substrate 2c.

For the antenna 1c with the above dimensions, FIG. 20 shows, as a function of frequency, the matching A and the transmission TC for the preferred, circular polarization rotating in the anticlockwise direction, compared to transmission TD rotating in the clockwise direction. The antenna resonates at a frequency around 2 GHz with matching of approximately 20% at 10 dB, which corresponds to a bandwidth of 410 MHz. The effective transmission bandwidth is narrower, of the order of 13%.

As an alternative to the above, the lengths of the raised portions 5c can be different for operation with elliptical polarization with one probe or crossed polarization with two probes.

The invention is not limited to the crossed parallelepiped-shaped raised portions 5c for operation with crossed polarizations, especially operation with circular polarization. For example, the two raised portions can be replaced by a central raised portion with axial symmetry about a central axis of symmetry ZZ perpendicular to the faces of the substrate 2d covered with the conductive layers 3d and 4d. In the example shown in FIG. 21, the raised portion 5d is in the shape of a macaroon. More generally, the raised portion has a discoid, frustoconical, conical, dome or bell shape, with a circular or elliptical base on the substrate. At least two feed coupler ends 84d are provided on the raised portion 5d, on two axes perpendicular to each other and to the axis of symmetry ZZ, at the same distance or different distances from the axis ZZ.

What we claim is:

1. A half-wave printed antenna comprising a dielectric substrate, two conductive layers extending on respective faces of the substrate and symmetrical with respect to a plane of symmetry of said antenna perpendicular to said faces of said substrate, and a raised portion extending lengthwise of said plane of symmetry on one face of said substrate, one of said conductive layers extending over and along said raised portion.

2. The antenna as claimed in claim 1, wherein said conductive layer extending over and along said raised portion constitutes a radiating element, and the other conductive layer constitutes a ground plane.

3. The antenna as claimed in claim 1, wherein said conductive layer extending over and along said raised portion constitutes a ground plane, and the other conductive layer constitutes a radiating element.

4. The antenna as claimed in claim 1, wherein said raised portion has a height substantially equal to half the distance between the lengths of the longer and shorter sides of the layer, which is rectangular, extending over and along said raised portion.

5. The antenna as claimed in claim 1, wherein said raised portion has a rectangular, sinusoidal, trapezoidal or triangular cross section in said plane of symmetry.

6. The antenna as claimed in claim 1, wherein said other face of said substrate includes another raised portion extending lengthwise of said plane of symmetry and covered by the other conductive layer.

7. The antenna as claimed in claim 1, wherein one face of said substrate includes two mutually perpendicular raised portions extending lengthwise of two respective planes of symmetry of said antenna.

8. The antenna as claimed in claim 7, wherein said conductive layer extending over and along said raised portions occupies a rectangular surface on said dielectric substrate whose sides are the same lengths as the respective raised portions.

9. The antenna as claimed in claim 7, including a hybrid coupler that is formed on a dielectric support and lodged in the dielectric substrate and has at least a port connected to an end of an inner conductor of a coaxial probe and at least another port connected by a metal via to said conductive layer extending over and along said raised portions.

10. The antenna as claimed in claim 7, wherein said two raised portions on one face of said substrate are replaced by a raised portion with axial symmetry about an axis perpendicular to said faces of said substrate.

11. A method of fabricating a half-wave printed antenna including a dielectric substrate and two conductive layers extending on respective faces of said substrate and symmetrical with respect to a plane of symmetry of said antenna perpendicular to said faces of said substrate, said method including machining one face of a block of dielectric substrate to form cavities separated by at least one strip having the same section as a raised portion extending lengthwise of said plane of symmetry, metallizing at least said face of said block with the machined dielectric raised portion to form one of said conductive layers, and cutting out said printed antenna substantially at the center of said metallized and machined block following the contour of said printed antenna.
